(19) United States
(12) Patent Application Publication
(10) Pub. No.: US 2024/0312010 A1
(43) Pub. Date: Sep. 19, 2024

(54) DETECTING A TISSUE TYPE IN AN IMAGE OF THE TISSUE

(71) Applicant: Bayer Aktiengesellschaft, Leverkussen (DE)

(72) Inventors: Josef CERSOVSKY, Berlin (DE); Johannes HÖHNE, Oranienburg (DE)

(73) Assignee: Bayer Aktiengesellschaft, Leverkusen (DE)

(21) Appl. No.: 18/607,316

(22) Filed: Mar. 15, 2024

(30) Foreign Application Priority Data
Mar. 17, 2023 (EP) 23162646.6

(51) Int. Cl. G06T 7/00; G06T 7/11; G06V 10/764

(52) U.S. Cl. CPC G06T 7/0012; G06T 7/11; G06V 10/764; G06T 2207/30024; G06T 2207/30096

(57) ABSTRACT

The systems, methods, and computer programs disclosed herein relate to detecting and/or recognizing a tissue type in an image of the tissue using machine learning techniques.

### CROSS REFERENCE TO RELATED APPLICATIONS

This application claims priority to European Application No. 23162646.6, filed on Mar. 17, 2023, the entire content of which is hereby incorporated by reference in its entirety.

### FIELD

The systems, methods, and computer programs disclosed herein relate to detecting and/or recognizing a tissue type in an image of the tissue using machine learning techniques.

### BACKGROUND

Multi-instance learning is common for computer vision tasks, especially in medical image processing.

Multiple-instance learning uses training sets that consist of bags where each bag contains several instances that are either positive or negative examples for the class of interest, but only bag-level labels are given, and the instance-level labels are unknown during training.

In the field of image classification, a multi-instance learning approach can be applied when the images are very large, i.e., have a very large number of pixels. Instead of training a machine learning model based on the complete images, it can be trained based on patches.

A patch is a subregion of an image which is smaller than the original image.

From an image a number of patches can be generated, and a machine learning model can be trained to:
generate a patch embedding for each patch,
aggregate patch embeddings into a bag-level representation, with each patch embedding assigned a learnable attention weight, and
classify the bag-level-representation into one of at least two classes.

Once the machine learning model is trained, it can be used to classify a new image into one of the two trained classes.

J. Hoehne et al. describe the use of such a multiple-instance learning approach to detect genetic alterations in tumor tissue samples: Detecting genetic alterations in BRAF and NTRK as oncogenic drivers in digital pathology images: towards model generalization within and across multiple thyroid cohorts, Proceedings of Machine Learning Research 156, 2021, pages 1-12.

For classifying a new image, patches can be generated from the new image. All generated patches or a selected number of the generated patches can be inputted into the trained machine learning model. The trained machine learning model outputs a classification result based on the inputted patches. Because not all patches of an image are relevant for the classification result, the classification result may be inaccurate.

### SUMMARY

This problem is solved by the subject matter of the independent claims. Preferred embodiments can be found in the dependent claims as well as in the description and the drawings.

Therefore, in a first aspect, the present disclosure provides a computer-implemented method of detecting and/or recognizing a tissue type in an image of the tissue, the method comprising:
providing a trained machine learning model,
   wherein the trained machine-learning model is configured and was trained on training data
      to receive a number of patches generated from an image of a tissue,
      to generate a patch embedding for each received patch,
      to aggregate patch embeddings into a bag-level representation, with each patch embedding assigned a learnable attention weight, and
      to classify the image into one of at least two classes based on the bag-level representation,
receiving a new image of a tissue,
generating a multitude of patches from the new image,
inputting the patches generated from the new image into the trained machine-learning model,
receiving from the trained machine learning model a first classification result,
   wherein the first classification result comprises information about which class of the two classes the new image was assigned to, and
   wherein the first classification result further comprises, for each patch inputted into the trained machine-learning model, an attention weight assigned to the patch embedding of the patch,
selecting a number of patches based on the attention weights,
inputting the selected patches and/or patches of regions comprising one or more selected patches into the trained machine learning model,
receiving from the trained machine learning model a second classification result,
   wherein the second classification result comprises information about which class of the two classes the new image was assigned to,
outputting the second classification result and/or storing the second classification result in a data memory and/or transmitting the second classification result to a separate computer system.

In another aspect, the present disclosure provides a computer system comprising: a processor; and a memory storing an application program configured to perform, when executed by the processor, an operation, the operation comprising:
providing a trained machine learning model,
   wherein the trained machine-learning model is configured and was trained on training data
      to receive a number of patches generated from an image of a tissue,
      to generate a patch embedding for each received patch,
      to aggregate patch embeddings into a bag-level representation, with each patch embedding assigned a learnable attention weight, and
      to classify the image into one of at least two classes based on the bag-level representation,
receiving a new image of a tissue,
generating a multitude of patches from the new image,
inputting the patches generated from the new image into the trained machine-learning model,
receiving from the trained machine learning model a first classification result,
   wherein the first classification result comprises information about which class of the two classes the new image was assigned to, and
   wherein the first classification result further comprises, for each patch inputted into the trained machine-learning model, an attention weight assigned to the patch embedding of the patch,
selecting a number of patches based on the attention weights,
inputting the selected patches and/or patches of regions comprising one or more selected patches into the trained machine learning model,
receiving from the trained machine learning model a second classification result,
   wherein the second classification result comprises information about which class of the two classes the new image was assigned to,
outputting the second classification result and/or storing the second classification result in a data memory and/or transmitting the second classification result to a separate computer system.

In another aspect, the present disclosure provides a non-transitory computer readable medium having stored thereon software instructions that, when executed by a processor of a computer system, cause the computer system to execute the following steps:
providing a trained machine learning model,
   wherein the trained machine-learning model is configured and was trained on training data
      to receive a number of patches generated from an image of a tissue,
      to generate a patch embedding for each received patch,
      to aggregate patch embeddings into a bag-level representation, with each patch embedding assigned a learnable attention weight, and
      to classify the image into one of at least two classes based on the bag-level representation,
receiving a new image of a tissue,
generating a multitude of patches from the new image,
inputting the patches generated from the new image into the trained machine-learning model,
receiving from the trained machine learning model a first classification result,
   wherein the first classification result comprises information about which class of the two classes the new image was assigned to, and
   wherein the first classification result further comprises, for each patch inputted into the trained machine-learning model, an attention weight assigned to the patch embedding of the patch,
selecting a number of patches based on the attention weights,
inputting the selected patches and/or patches of regions comprising one or more selected patches into the trained machine learning model,
receiving from the trained machine learning model a second classification result,
   wherein the second classification result comprises information about which class of the two classes the new image was assigned to,
outputting the second classification result and/or storing the second classification result in a data memory and/or transmitting the second classification result to a separate computer system.

### BRIEF DESCRIPTION OF THE DRAWINGS

FIG. 1 schematically shows an embodiment of the method for training the machine learning model of the present disclosure.

FIG. 2 schematically shows an embodiment of the machine learning model of the present disclosure in more detail.

FIG. 3 schematically shows an embodiment of the method of classifying a new image into one of at least two classes using the trained machine learning model of the present disclosure.

FIG. 4 shows an embodiment of the computer-implemented method of the present disclosure in the form of a flow chart.

FIG. 5 shows another embodiment of the computer-implemented method of the present disclosure in the form of a flow chart.

FIG. 6 illustrates a computer system according to some example implementations of the present disclosure in more detail.

FIG. 7 shows the results of six classifications using the trained machine learning model of the present disclosure.

### DETAILED DESCRIPTION

The subject matter of the present disclosure will be more particularly elucidated below without distinguishing between the aspects of the disclosure (method, computer system, computer-readable storage medium). On the contrary, the following elucidations are intended to apply analogously to all the aspects of the disclosure, irrespective of in which context (method, computer system, computer-readable storage medium) they occur.

If steps are stated in an order in the present description or in the claims, this does not necessarily mean that the disclosure is restricted to the stated order. On the contrary, it is conceivable that the steps can also be executed in a different order or else in parallel to one another, unless one step builds upon another step, this absolutely requiring that the building step be executed subsequently (this being, however, clear in the individual case). The stated orders are thus preferred embodiments of the invention.

As used herein, the articles “a” and “an” are intended to include one or more items and may be used interchangeably with “one or more” and “at least one.” As used in the specification and the claims, the singular form of “a”, “an”, and “the” include plural referents, unless the context clearly dictates otherwise. Where only one item is intended, the term “one” or similar language is used. Also, as used herein, the terms “has”, “have”, “having”, or the like are intended to be open-ended terms. Further, the phrase “based on” is intended to mean “based at least partially on” unless explicitly stated otherwise. Further, the phrase “based on” may mean “in response to” and be indicative of a condition for automatically triggering a specified operation of an electronic device (e.g., a controller, a processor, a computing device, etc.) as appropriately referred to herein.

Some implementations of the present disclosure will be described more fully hereinafter with reference to the accompanying drawings, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art.

The present disclosure provides means for detecting and/or recognizing a tissue type in an image of the tissue.

The “tissue” may be a body tissue of a human or animal or plant or fungus or another organism.

The term “image” as used herein means a data structure that represents a spatial distribution of a physical signal. The spatial distribution may be of any dimension, for example 2D, 3D, 4D or any higher dimension. The spatial distribution may be of any shape, for example forming a grid and thereby defining pixels, the grid being possibly irregular or regular. The physical signal may be any signal, for example proton density, tissue echogenicity, tissue radiolucency, measurements related to the blood flow, information of rotating hydrogen nuclei in a magnetic field, color, level of gray, depth, surface or volume occupancy, such that the image may be a 2D or 3D RGB/grayscale/depth image, or a 3D surface/volume occupancy model. The image may be a photography or frame from a video.

For simplicity, the invention is described herein mainly on the basis of two-dimensional images consisting of a rectangular array of pixels. However, this is not to be understood as limiting the invention to such images. Those skilled in machine learning based on image data will know how to apply the invention to image data comprising more dimensions and/or being in a different format.

In a preferred embodiment, the image is a medical image.

A “medical image” is a preferably visual representation of the human body or a part thereof or a visual representation of the body of an animal or a part thereof. Medical images can be used, e.g., for diagnostic and/or treatment purposes. A widely used format for digital medical images is the DICOM format (DICOM: Digital Imaging and Communications in Medicine).

Techniques for generating medical images include X-ray radiography, computerized tomography, fluoroscopy, magnetic resonance imaging, ultrasonography, endoscopy, clastography, tactile imaging, thermography, microscopy, positron emission tomography, optical coherence tomography, fundus photography, and others.

Examples of medical images include CT (computer tomography) scans, X-ray images, MRI (magnetic resonance imaging) scans, fluorescein angiography images, OCT (optical coherence tomography) scans, histopathological images, ultrasound images, fundus images and/or others.

In an embodiment, the image is a microscopic image, such as a whole slide histopathological image of a tissue of a human body. The histopathological image can be an image of a stained tissue sample. One or more dyes can be used to create the stained image. Usual dyes are hematoxylin and cosin.

In another embodiment, the image is a radiological image. Radiology” is the branch of medicine concerned with the application of electromagnetic radiation and mechanical waves (including, for example, ultrasound diagnostics) for diagnostic, therapeutic and/or scientific purposes. In addition to X-rays, other ionizing radiation such as gamma rays or electrons are also used. Since a primary purpose is imaging, other imaging procedures such as sonography and magnetic resonance imaging (MRI) are also included in radiology, although no ionizing radiation is used in these procedures. Thus, the term “radiology” as used in the present disclosure includes, in particular, the following examination procedures: computed tomography, magnetic resonance imaging, sonography.

The radiological image can be, e.g., a 2D or 3D CT scan or MRI scan. The radiological image may be an image generated using a contrast agent or without a contrast agent. It may also be multiple images, one or more of which were generated using a contrast agent and one or more of which were generated without a contrast agent.

“Contrast agents” are substances or mixtures of substances that improve the visualization of structures and functions of the body during radiological examinations.

In computed tomography, solutions containing iodine are usually used as contrast agents. In magnetic resonance imaging (MRI), superparamagnetic substances (e.g., iron oxide nanoparticles, superparamagnetic iron platinum particles (SIPPs)) or paramagnetic substances (e.g., gadolinium chelates, manganese chelates) are commonly used as contrast agents. In the case of sonography, fluids containing gas-filled microbubbles (microbubbles) are usually administered intravenously.

Images used for training are assigned to one of at least two classes. In other words, each image of the training data belongs to one of at least two classes. The number of classes can be 2 or 3 or 4 or more.

In one embodiment, each image used for training is assigned to one of exactly two classes, one class representing images that show a specific tissue type and the other class representing images that do not show the specific tissue type (binary classification).

In another embodiment, each image used for training is assigned to one of more than two classes, each class representing a specific tissue type (multiclass classification).

The specific tissue type may be, for example, muscle tissue, fat tissue, bone tissue, cartilage tissue, tissue of a specific organ such as the lung, liver, kidney, thyroid, breast, prostate, pancreas and/or the like.

The specific tissue type may be diseased or healthy tissue. The specific tissue may be tissue from a lesion or edema. The specific tissue may be cancerous tissue. The tissue may be tissue affected by a specific type of cancer. Exemplary cancers include, but are not limited to, adrenocortical carcinoma, bladder urothelial carcinoma, breast invasive carcinoma, cervical squamous cell carcinoma, endocervical adenocarcinoma, colon adenocarcinoma, esophageal carcinoma, kidney renal clear cell carcinoma, kidney renal papillary cell carcinoma, liver hepatocellular carcinoma, lung adenocarcinoma, lung squamous cell carcinoma, ovarian serous cystadenocarcinoma, pancreatic adenocarcinoma, prostate adenocarcinoma, rectal adenocarcinoma, skin cutaneous melanoma, stomach adenocarcinoma, thyroid carcinoma, uterine corpus endometrial carcinoma, and cholangiocarcinoma.

The tissue may be tissue that has one or more specific genetic defects. Examples of genes related to proliferation of cancer include HER2, TOP2A, HER3, EGFR, P53, and MET. Examples of tyrosine kinase related genes include ALK, FLT3, AXL, FLT4 (VEGFR3, DDR1, FMS(CSF1R), DDR2, EGFR(ERBB1), HER4(ERBB4), EML4-ALK, IGF1R, EPHA1, INSR, EPHA2, IRR(INSRR), EPHA3, KIT, EPHA4, LTK, EPHA5, MER(MERTK), EPHA6, MET, EPHA7, MUSK, EPHA8, NPM1-ALK, EPHB1, PDGFRα(PDGFRA), EPHB2, PDGFRβ(PDGFRB)EPHB3, RET, EPHB4, RON(MST1R), FGFR1, ROS(ROS1), FGFR2, TIE2(TEK), FGFR3, TRKA(NTRK1), FGFR4, TRKB(NTRK2), FLT1(VEGFR1), and TRKC(NTRK3). Examples of breast cancer related genes include ATM, BRCA1, BRCA2, BRCA3, CCND1, E-Cadherin, ERBB2, ETV6, FGFR1, HRAS, KRAS, NRAS, NTRK3, p53, and PTEN. Examples of genes related to carcinoid tumors include BCL2, BRD4, CCND1, CDKN1A, CDKN2A, CTNNB1, HES1, MAP2, MEN1, NF1, NOTCH1, NUT, RAF, SDHD, and VEGFA. Examples of colorectal cancer related genes include APC, MSH6, AXIN2, MYH, BMPR1A, p53, DCC, PMS2, KRAS2 (or Ki-ras), PTEN, MLH1, SMAD4, MSH2, STK11, and MSH6. Examples of lung cancer related genes include ALK, PTEN, CCND1, RASSF1A, CDKN2A, RB1, EGFR, RET, EML4, ROS1, KRAS2, TP53, and MYC. Examples of liver cancer related genes include Axin1, MALAT1, b-catenin, p16 INK4A, c-ERBB-2, p53, CTNNB1, RB1, Cyclin D1, SMAD2, EGFR, SMAD4, IGFR2, TCF1, and KRAS. Examples of kidney cancer related genes include Alpha, PRCC, ASPSCR1, PSF, CLTC, TFE3, p54nrb/NONO, and TFEB. Examples of thyroid cancer related genes include AKAP10, NTRK1, AKAP9, RET, BRAF, TFG, ELE1, TPM3, H4/D10S170, and TPR. Examples of ovarian cancer related genes include AKT2, MDM2, BCL2, MYC, BRCA1, NCOA4, CDKN2A, p53, ERBB2, PIK3CA, GATA4, RB, HRAS, RET, KRAS, and RNASET2. Examples of prostate cancer related genes include AR, KLK3, BRCA2, MYC, CDKN1B, NKX3.1, EZH2, p53, GSTP1, and PTEN. Examples of bone tumor related genes include CDH11, COL12A1, CNBP, OMD, COL1A1, THRAP3, COL4A5, and USP6.

The specific tissue may be cancerous tissue caused by a specific gene mutation, such as a mutation of a neurotrophic receptor tyrosine kinase (NTRK) gene or BRAF gene.

In a first step, a trained machine learning model is provided. Such a “machine learning model”, as used herein, may be understood as a computer implemented data processing architecture. The machine learning model can receive input data and provide output data based on that input data and on parameters of the machine learning model (model parameters). The machine learning model can learn a relation between input data and output data through training. In training, parameters of the machine learning model may be adjusted in order to provide a desired output for a given input.

The process of training a machine learning model involves providing a machine learning algorithm (that is the learning algorithm) with training data to learn from. The term “trained machine learning model” refers to the model artifact that is created by the training process. The training data must contain the correct answer, which is referred to as the target. The learning algorithm finds patterns in the training data that map input data to the target, and it outputs a trained machine learning model that captures these patterns.

In the training process, training data are inputted into the machine learning model and the machine learning model generates an output. The output is compared with the (known) target. Parameters of the machine learning model are modified in order to reduce the deviations between the output and the (known) target to a (defined) minimum.

In general, a loss function can be used for training, where the loss function can quantify the deviations between the output and the target. The loss function may be chosen in such a way that it rewards a wanted relation between output and target and/or penalizes an unwanted relation between an output and a target. Such a relation can be, e.g., a similarity, or a dissimilarity, or another relation.

A loss function can be used to calculate a loss for a given pair of output and target. The aim of the training process can be to modify (adjust) parameters of the machine learning model in order to reduce the loss to a (defined) minimum. The loss can be, for example, a cross-entropy loss, in case of a binary classification it can be, for example a binary cross-entropy loss.

The machine learning model of the present disclosure is trained on training data. The training data comprise a multitude of tissue images. The term “multitude” means more than 10, preferably more than 100.

Each of the tissue images may show the same tissue(s), such as lung tissue, breast tissue, liver tissue, thyroid tissue, skin tissue, bone tissue, and/or other tissue. It is possible that the tissue(s) shown in the images is(are) from different individuals.

Each image is annotated (labelled), i.e., there is information which of the class of the at least two classes the image is assigned to (class information).

The images—or more precisely patches generated from the image—are used as input data when training the machine learning model; the class information is used as target.

The machine learning model is configured and trained to:
receive a number of patches generated from an image of a tissue,
generate a patch embedding for each received patch,
aggregate patch embeddings into a bag-level representation, with each patch embedding assigned a learnable attention weight, and
classify the bag-level-representation into one of at least two classes.

A “patch” is a subregion of an image which is smaller than the original image.

Patches can be of arbitrary size and dimensions. A patch may have the same dimensionality than the source image (e.g., 2D histopathology image→2D histopathology patch; 3D CT scan→3D CT patch), or it may have different dimensionality (e.g., 3D CT scan→2D slice patch).

Patches can be generated from an image by dividing the image into a predefined number of patches (e.g., 100, 512, 1000 or any other number).

Patches can be created from 2D images by dividing the 2D image into smaller areas.

Patches can be created from 3D images (or even higher-dimensional images) by cutting slices of a defined thickness (e.g., a voxel) from the 3D image. A patch can be a single CT or MRI slice, such as an axial slide, a sagittal slice, or a coronal slice.

Usually, 2D patches have a square or rectangular shape. In case of a quadratic or rectangular 2D image, the resolution of a patch is usually in the range of 32 pixels×32 pixels to 10.000 pixels×10.000 pixels, preferably in the range of 128 pixels×128 pixel to 4096 pixels×4096 pixels.

It is possible that patches are discarded if they do not meet a pre-defined requirement. For example, a patch can be discarded if the amount of tissue in the patch is below a predefined threshold (e.g., 5% or 10% or 20% or any other percentage).

When training the machine learning model, a predefined number of patches of an image are input to the machine learning model, e.g., 10 or 20, or 30, or 50 or 100 or any other number.

The machine learning model is configured and trained to generate a patch embedding for each patch inputted into the machine learning model.

A “patch embedding” is a numerical representation of the patch. The machine learning model is configured and trained to extract and aggregate those features of the patch that are essential for the classification. The generation of a patch embedding is therefore usually accompanied by a dimension reduction.

Usually, the machine learning model includes convolution and pooling operations to generate a patch embedding from a patch. For example, the machine learning model may be or include a convolutional neural network (CNN).

A “CNN” is a class of artificial neural networks, most commonly applied to analyzing visual imagery. A CNN comprises an input layer with input neurons, an output layer with output neurons, as well as multiple hidden layers between the input layer and the output layer.

The input layer may be used to receive a patch. The output layer may be used to output a patch embedding. The output layer usually has fewer output neurons than the input layer has input neurons.

The hidden layers of a CNN typically consist of convolutional layers, activation function (e.g., ReLU (Rectified Linear Units)), pooling layers, fully connected layers and normalization layers.

Usually, the neurons in the CNN input layer are organized into a set of “filters” (feature detectors), and the output of each set of filters is propagated to neurons in successive layers of the network. The computations for a CNN include applying the convolution mathematical operation to each filter to produce the output of that filter. Convolution is a specialized kind of mathematical operation performed by two functions to produce a third function that is a modified version of one of the two original functions. In convolutional network terminology, the first function to the convolution can be referred to as the input, while the second function can be referred to as the convolution kernel. The output may be referred to as the feature map. For example, the input to a convolution layer can be a multidimensional array of data that defines the various color components of an input patch. The convolution kernel can be a multidimensional array of parameters, where the parameters are adapted by the training process for the neural network.

The objective of the convolution operation is to extract features (such as, e.g., edges from an input image). Conventionally, the first convolutional layer is responsible for capturing the low-level features such as edges, color, gradient orientation, etc. With added layers, the architecture adapts to the high-level features as well, giving a network which has the wholesome understanding of patches in the dataset. Similar to the convolutional layer, the pooling layer is responsible for reducing the spatial size of the feature maps. It is useful for extracting dominant features with some degree of rotational and positional invariance, thus maintaining the process of effectively training of the model. Adding a fully-connected layer is a way of learning non-linear combinations of the high-level features as represented by the output of the convolutional part.

However, the machine learning model can also be a transformer network (see, e.g., D. Karimi et al.: Convolution-Free Medical Image Segmentation using Transformers, arXiv:2102.13645) or a combination of a transformer network and a CNN (see, e.g., K. Cao et al.: A CNN-transformer fusion network for COVID-19 CXR image classification, PLOS One, 2022 17(10): e0276758) or another machine learning model.

The machine learning model is further configured and trained to combine (aggregate) a predefined number of patch embeddings into a joint representation (e.g., 10, 20, 30, 50, 100 or any other number of patch embeddings). The joint representation is also referred to as a bag-level representation in this disclosure, since it corresponds to a bag in the multi-instance learning approach. The patches correspond to the instances and the patch embeddings to instance embeddings in the multi-instance learning approach (sec, e.g., M. Ilse et al.: Attention-based Deep Multiple Instance Learning, arXiv: 1802.04712v4; J. Amores: Multiple instance classification: Review, taxonomy and comparative study, Artificial Intelligence 201 (2013) 81-105).

When aggregating patch embeddings into a bag-level representation, each patch embedding is assigned an attention weight.

Attention weights are based on learnable parameters, i.e., during training, the machine learning model learns model parameters from which attention weights for the patches (more precisely for the patch embeddings of the patches) can be derived.

In machine learning, attention is a technique that mimics cognitive attention. The effect enhances some parts of the input data while diminishing other parts-the thought being that the machine learning model should devote more focus to that small but important part of the data. Learning which part of the data is more important than others is trained in the training phase.

The bag-level representation can, e.g., be based on a weighted sum of all patch embeddings inside the bag. For example, let H={h₁, h₂, . . . , hₘ} be a bag of a number m of patch embeddings, the bag-level representation Z can be

$$Z = {\sum }_{i = 1}^{m} {a}_{i} \cdot {h}_{i} \qquad ( Eq . 1 )$$

wherein aᵢ is the attention weight of the patch embedding hᵢ, and i is an index that takes the values from 1 to m.

The attention weights can be defined as

$${a}_{k} = \frac{exp ( {Ch}_{k}^{T} )}{{\sum }_{i = 1}^{m} exp ( {Ch}_{i}^{T} )} \qquad ( Eq . 2 )$$

wherein C is a learnable parameter with the same dimensionality as hᵢ, and k is an integer for which applies: 1≤k≤m.

There are other examples of the calculation of attentional weights in the scientific literature, e.g.:

$${a}_{k} = \frac{exp ( {w}^{T} tanh ( {Vh}_{k}^{T} ) )}{{\sum }_{i = 1}^{k} exp ( {w}^{T} tanh ( {Vh}_{i}^{T} ) )} \qquad ( Eq . 3 )$$

$$or$$

$${a}_{k} = \frac{exp \{ {w}^{T} ( tanh ( {Vh}_{k}^{T} ) ⊙ sigm ( {Uh}_{k}^{T} ) ) \}}{{\sum }_{i = 1}^{k} exp \{ {w}^{T} ( tanh ( {Vh}_{i}^{T} ) ⊙ sigm ( {Uh}_{i}^{T} ) ) \}} \qquad ( Eq . 4 )$$

wherein w, V, and U are learnable parameters, \hat{·} is an element-wise multiplication, sigm(·) is the sigmoid non-linearity, and tanh is the hyberbolic tangent, as disclosed by M. Ilse et al.: Attention-based Deep Multiple Instance Learning, arXiv: 1802.04712v4.

Furthermore, the bag-level representation can be calculated by formulas other than Eq. 1. In other words, the present invention is not limited to any particular calculation of the bag-level representation and/or attention weights. All that is important is that the bag-level representation allows for classification and the attention weights give patch embeddings a higher weight the more relevant they are to the classification result.

For example, A. V. Konstantinov and L. V. Utkin propose not only to use the patch embeddings of selected patches to calculate the bag-level representation, but also to consider neighboring patches (Multi-Attention Multiple Instance Learning, arXiv:2112.06071v1). The patent applications WO2023194090A1, WO2023/208663A1, and WO2023/213623A1 propose to consider not only nearest neighbors, but to aggregate neighbors of different distances at different levels. All of these techniques and/or others can be used to calculate the attention weights and/or bag-level representation of the present disclosure.

In a preferred embodiment, the patch embeddings aggregation operator is permutation invariant since the order of patches in a bag does not matter. Furthermore, the patch embeddings aggregation operator is preferably differentiable in order to implement it as part of an artificial neural network which then can be trained end-to-end to perform the classification task.

The machine learning model is further configured and trained to assign the bag-level representation to one class of the at least two classes. In other words: the machine learning model is further configured and trained to assign the image to one class of the at least two classes based on the bag-level representation.

The class may indicate whether the tissue shown in the image has a certain property or does not have the certain property.

The class may indicate whether the tissue shown in the image is a specific tissue or not.

The class may indicate the specific tissue type.

The class may indicate whether the tissue shown in the image is a lesion, or an edema or a tumor.

The class may indicate whether there is a specific gene mutation in the tissue shown in the image.

The class may indicate whether the tissue depicted in the image is tumor tissue and/or may specify the type of tumor present in the tissue.

The class may indicate whether the subject from which the tissue depicted in the image originates has a particular disease or does not have the particular disease.

The class may indicate the severity of a particular disease.

Further options for classes are described elsewhere in this disclosure.

The process of training the machine learning model typically includes the following steps:
providing a machine learning model, wherein the machine learning model is configured to
   receive a number of patches generated from an image,
   generate a patch embedding for each patch of the number of patches,
   aggregate patch embeddings into a bag-level representation, with each patch embedding assigned a learnable attention weight, and
   classify the image into one of at least two classes based on the bag-level representation and based on model parameters,
receiving and/or providing training data, the training data comprising a multitude of images of tissue and class information, the class information indicating which class of at least two classes each image belongs to,
inputting a number of patches generated from an image of the multitude of images into the machine learning model,
receiving from the machine learning model a classification result, the classification result comprising an information about which class of the at least two classes the image was assigned to by the machine learning model,
quantifying a deviation between the class the image belongs to and the class the image was assigned to by the machine learning model,
reducing the deviation by modifying parameters of the machine learning model.

The machine learning model can be one of the models described in the following publications: J. Hoehne et al.: Detecting genetic alterations in BRAF and NTRK as oncogenic drivers in digital pathology images: towards model generalization within and across multiple thyroid cohorts, Proceedings of Machine Learning Research 156, 2021, pages 1-12; J. Dippel et al.: Towards Fine-grained Visual Representations by Combining Contrastive Learning with Image Reconstruction and Attention-weighted Pooling, arXiv:2104.04323v2; A. V. Konstantinov et al.:, Multi-Attention Multiple Instance Learning, arXiv:2112.06071v1; M. Ilse et al.: Attention-based Deep Multiple Instance Learning, arXiv: 1802.04712v4; H. D. Couture: Deep Learning-Based Prediction of Molecular Tumor Biomarkers from H&E: A Practical Review, J. Pers. Med. 2022, 12, 2022; C.-L. Chen et al.: An annotation-free whole-slide training approach to pathological classification of lung cancer types using deep learning; Nature Communications (2021) 12:1193; C. L. Srinidhi et al.: Deep neural network models for computational histopathology: A survey, arXiv: 1912.12378v2.

Once the machine learning model is trained, the trained machine learning model can be used to classify new images. The term “new” means that the images have not been used in training the machine learning model.

In a first step, a new tissue image is received. For simplicity, the invention is explained below on the basis of a single image; however, it is also possible for multiple images to be received and processed as described in this disclosure, e.g., images of different modalities and/or images generated according to different measurement protocols and/or the like.

The term “receiving” includes both retrieving an image and accepting an image transmitted, for example, to the computer system of the present disclosure. The image may be received from a computed tomography scanner, from a magnetic resonance imaging scanner, from an ultrasound scanner, from a microscope slide scanner and/or from any other image generating and/or processing device. The image may be read from one or more data storage devices and/or transmitted from a separate computer system.

From the new image a number of patches is generated. The generation of patches from the new image corresponds to the generation of patches from the images of the training data when training the machine learning model. So, for example, the image can be divided into a predefined number of patches; patches that do not meet a pre-defined requirement may be discarded.

In an embodiment of the present disclosure, all patches generated from the new image (except for patches that may have been discarded) are inputted to the trained machine learning model as input data.

Patches can be input to the machine learning model in the form of batches, where a batch typically includes as many patches as patch embeddings are aggregated into a bag-level representation.

The trained machine learning model processes the inputted patches as it was trained:
it generates a patch embedding for each inputted patch,
it aggregates patch embeddings into a bag-level representation, with each patch embedding assigned an attention weight,
it classifies the bag-level representation into one of the at least two classes, and
it outputs a first classification result, the first classification result comprising information about which class of the two classes the bag-level representation was assigned to.

However, the information to which class the bag-level representation has been assigned is irrelevant. It is only a kind of preliminary classification result (an intermediate classification result) based on, e.g., randomly selected patches or all patches generated from the new image. To achieve an improved classification result, the classification is performed a second time, based on selected patches.

The patches are selected based on the attention weights assigned to the corresponding patch embeddings during the first classification. The trained machine learning model is configured to output these attention weights for the corresponding patch embeddings.

Thus, when a number q of patches P(I)₁, . . . , P(I)_{q} of an image I are inputted into the trained machine learning model, the trained machine learning model generates a patch embedding hᵢ for each input patch P(I)ᵢ and assigns an attention weight aᵢ to the patch embedding hᵢ, wherein i is an index that takes the values from 1 to q.

For each of the patch embeddings hi, the corresponding attention weight aᵢ is outputted. A number m of patches P*(I)₁, . . . , P*(I)ₘ is then selected based on the attention weights.

For example, it is possible to rank the patches according to the size of the attention weights of their patch embeddings and select from this ranking a defined number of patches with the highest attention weights, e.g., the top 10 or top 30 or top 100 or any other number. Likewise, it is possible to select those patches for which the attention weights of their patch embeddings are greater than a given threshold, e.g., greater than 0.2 or any other threshold.

It is also possible to split the patches into a group of low attention weights and a group of high attention weights (according to the attention weights of their patch embeddings) and select the patches in the group of high attention weights. The split can be done by k-means clustering, thresholding, top-k selection, fitting a Gaussian mixed model and/or the like.

It is also possible to select those patches with a higher probability whose patch embeddings have a higher attention weight.

Similarly, it is possible to divide the new image into regions and select patches from those regions that have the most patches with the highest patch embedding attention weights or that have the most patches with patch embedding attention weights above a predefined threshold.

That means, it is possible to select also other patches than patches used in the first classification, e.g., due to a spatial proximity to a patch with a high attention weight in the first classification.

The selected patches are inputted into the trained machine learning model. The trained machine learning model processes the selected patches in the way it was trained:
it generates a patch embedding for each inputted selected patch,
it aggregates patch embeddings into a bag-level representation, with each patch embedding assigned an attention weight,
it classifies the bag-level representation into one of the at least two classes, and
it outputs a second classification result, the second classification result comprising information about which class of the two classes the bag-level representation was assigned to.

The second classification result can be the final classification result. That is, the class to which the bag-level representation was assigned is deemed to be the class to which the new image belongs. The second (final) classification result may be outputted (e.g., displayed on a monitor or printed using a printer), stored in data storage device and/or transmitted to a separate computer system.

However, it is also possible that the process is repeated, and patches are again selected based on attention weights of their patch embeddings in the second classification, and a third classification is performed based on these selected patches. This can be particularly useful if patches are selected because they are in the neighborhood of patches whose patch embeddings have high attention weights. The third classification result can be output as the final classification result. The process can also be performed more than three times.

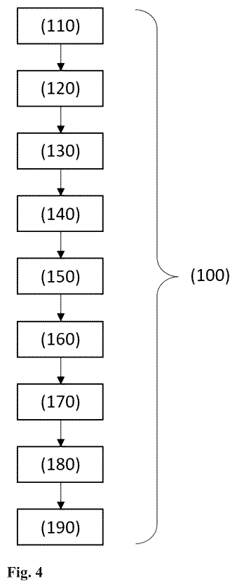

Instead of or in addition to the classification result, i.e., an information to which class of at least two classes the new image has been assigned, the new image can be output, where those patches can be marked that have contributed to the classification result. For example, a heat map can be output in which patches are colored according to their weights (as it is shown, e.g., in FIG. 4 of Chen et al.: An annotation-free whole-slide training approach to pathological classification of lung cancer types using deep learning; Nature Communications (2021) 12:1193, or in FIG. 15 of A. V. Konstantinov et al.: Multi-Attention Multiple Instance Learning, arXiv:2112.06071v1). In this way, a user (e.g., a physician) can identify which areas in the new image have a specific tissue (e.g., a diseased tissue).

The classification result can be used by a user (e.g., a physician) to make a diagnosis and/or to initiate further investigation.

If the result of the classification is that the new image shows a diseased tissue, a physician can take measures to treat the diseased tissue.

If the classification result indicates that tissue with a gene mutation is present (e.g., a mutation of a NTRK gene or BRAF gene), the physician may initiate genetic analysis of the tissue to confirm the finding.

The machine learning model of the present disclosure can be trained to perform various tasks. Accordingly, the trained machine learning model of the present disclosure can be used for various purposes. In a preferred embodiment, the machine learning model of the present disclosure is trained and the trained machine learning model is uses to detect, identify, and/or characterize tumor types and/or gene mutations in tissues.

The machine learning model can be trained and the trained machine learning model can be used to recognize a specific gene mutation and/or a specific tumor type, or to recognize multiple gene mutations and/or multiple tumor types.

The machine learning model can be trained and the trained machine learning model can be used to characterize the type or types of cancer a patient or subject has.

The machine learning model can be trained and the trained machine learning model can be used to select one or more effective therapies for the patient.

The machine learning model can be trained and the trained machine learning model can be used to determine how a patient is responding over time to a treatment and, if necessary, to select a new therapy or therapies for the patient as necessary.

Correctly characterizing the type or types of cancer a patient has and, potentially, selecting one or more effective therapies for the patient can be crucial for the survival and overall wellbeing of that patient.

The machine learning model can be trained and the trained machine learning model can be used to determine whether a patient should be included or excluded from participating in a clinical trial.

The machine learning model can be trained and the trained machine learning model can be used to classify images of tumor tissue in one or more of the following classes: inflamed, non-inflamed, vascularized, non-vascularized, fibroblast-enriched, non-fibroblast-enriched (such classes are defined, e.g., in EP3639169A1).

The machine learning model can be trained and the trained machine learning model can be used to identify differentially expressed genes in a sample from a subject (e.g., a patient) having a cancer (e.g., a tumor).

The machine learning model can be trained and the trained machine learning model can be used to identify genes that are mutated in a sample from a subject having a cancer (e.g., a tumor).

The machine learning model can be trained and the trained machine learning model can be used to identify a cancer (e.g., a tumor) as a specific subtype of cancer selected.

Such uses may be useful for clinical purposes including, for example, selecting a treatment, monitoring cancer progression, assessing the efficacy of a treatment against a cancer, evaluating suitability of a patient for participating in a clinical trial, or determining a course of treatment for a subject (e.g., a patient).

The trained machine learning model may also be used for non-clinical purposes including (as a non-limiting example) research purposes such as, e.g., studying the mechanism of cancer development and/or biological pathways and/or biological processes involved in cancer, and developing new therapies for cancer based on such studies.

The machine learning model of the present disclosure is trained based on images and it generates predictions based on images. The images usually show the tissue of one or more subjects. The images can be created from tissue samples of a subject. The subject is usually a human, but may also be any mammal, including mice, rabbits, dogs, and monkeys.

The tissue sample may be any sample from a subject known or suspected of having cancerous cells or pre-cancerous cells.

The tissue sample may be from any source in the subject's body including, but not limited to, skin (including portions of the epidermis, dermis, and/or hypodermis), bone, bone marrow, brain, thymus, spleen, small intestine, appendix, colon, rectum, liver, gall bladder, pancreas, kidney, lung, ureter, bladder, urethra, uterus, ovary, cervix, scrotum, penis, prostate.

The tissue sample may be a piece of tissue, or some or all of an organ.

The tissue sample may be a cancerous tissue or organ or a tissue or organ suspected of having one or more cancerous cells.

The tissue sample may be from a healthy (e.g. non-cancerous) tissue or organ.

The tissue sample may include both healthy and cancerous cells and/or tissue.

In certain embodiments, one sample has been taken from a subject for analysis. In some embodiments, more than one (e.g., 2, 3, 4, 5, 6, 7, 8, 9, 10, 11, 12, 13, 14, 15, 16, 17, 18, 19, 20, or more) samples may have been taken from a subject for analysis.

In some embodiments, one sample from a subject will be analyzed. In certain embodiments, more than one (e.g., 2, 3, 4, 5, 6, 7, 8, 9, 10, 11, 12, 13, 14, 15, 16, 17, 18, 19, 20, or more) samples may be analyzed. If more than one sample from a subject is analyzed, the samples may have been procured at the same time (e.g., more than one sample may be taken in the same procedure), or the samples may have been taken at different times (e.g., during a different procedure including a procedure 1, 2, 3, 4, 5, 6, 7, 8, 9, 10 days; 1, 2, 3, 4, 5, 6, 7, 8, 9, 10 weeks; 1, 2, 3, 4, 5, 6, 7, 8, 9, 10 months, 1, 2, 3, 4, 5, 6, 7, 8, 9, 10 years, or 1, 2, 3, 4, 5, 6, 7, 8, 9, 10 decades after a first procedure). A second or subsequent sample may be taken or obtained from the same region (e.g., from the same tumor or area of tissue) or a different region (including, e.g. a different tumor). A second or subsequent sample may be taken or obtained from the subject after one or more treatments and may be taken from the same region or a different region. As a non-limiting example, the second or subsequent sample may be useful in determining whether the cancer in each sample has different characteristics (e.g., in the case of samples taken from two physically separate tumors in a patient) or whether the cancer has responded to one or more treatments (e.g., in the case of two or more samples from the same tumor prior to and subsequent to a treatment).

Any of the samples described herein may have been obtained from the subject using any known technique. In some embodiments, the sample may have been obtained from a surgical procedure (e.g., laparoscopic surgery, microscopically controlled surgery, or endoscopy), bone marrow biopsy, punch biopsy, endoscopic biopsy, or needle biopsy (e.g., a fine-needle aspiration, core needle biopsy, vacuum-assisted biopsy, or image-guided biopsy).

Detection, identification, and/or characterization of tumor types may be applied to any cancer and any tumor. Exemplary cancers include, but are not limited to, adrenocortical carcinoma, bladder urothelial carcinoma, breast invasive carcinoma, cervical squamous cell carcinoma, endocervical adenocarcinoma, colon adenocarcinoma, esophageal carcinoma, kidney renal clear cell carcinoma, kidney renal papillary cell carcinoma, liver hepatocellular carcinoma, lung adenocarcinoma, lung squamous cell carcinoma, ovarian serous cystadenocarcinoma, pancreatic adenocarcinoma, prostate adenocarcinoma, rectal adenocarcinoma, skin cutaneous melanoma, stomach adenocarcinoma, thyroid carcinoma, uterine corpus endometrial carcinoma, and cholangiocarcinoma.

The machine learning model can be trained and the trained machine learning model can be used to detect, identify and/or characterize gene mutations in tissue samples.

Examples of genes related to proliferation of cancer or response rates of molecular target drugs include HER2, TOP2A, HER3, EGFR, P53, and MET. Examples of tyrosine kinase related genes include ALK, FLT3, AXL, FLT4 (VEGFR3, DDR1, FMS(CSF1R), DDR2, EGFR(ERBB1), HER4(ERBB4), EML4-ALK, IGF1R, EPHA1, INSR, EPHA2, IRR(INSRR), EPHA3, KIT, EPHA4, LTK, EPHA5, MER(MERTK), EPHA6, MET, EPHA7, MUSK, EPHA8, NPM1-ALK, EPHB1, PDGFRα(PDGFRA), EPHB2, PDGFRβ(PDGFRB)EPHB3, RET, EPHB4, RON(MST1R), FGFR1, ROS(ROS1), FGFR2, TIE2(TEK), FGFR3, TRKA(NTRK1), FGFR4, TRKB(NTRK2), FLT1(VEGFR1), and TRKC(NTRK3). Examples of breast cancer related genes include ATM, BRCA1, BRCA2, BRCA3, CCND1, E-Cadherin, ERBB2, ETV6, FGFR1, HRAS, KRAS, NRAS, NTRK3, p53, and PTEN. Examples of genes related to carcinoid tumors include BCL2, BRD4, CCND1, CDKN1A, CDKN2A, CTNNB1, HES1, MAP2, MEN1, NF1, NOTCH1, NUT, RAF, SDHD, and VEGFA. Examples of colorectal cancer related genes include APC, MSH6, AXIN2, MYH, BMPR1A, p53, DCC, PMS2, KRAS2 (or Ki-ras), PTEN, MLH1, SMAD4, MSH2, STK11, and MSH6. Examples of lung cancer related genes include ALK, PTEN, CCND1, RASSF1A, CDKN2A, RB1, EGFR, RET, EMLA, ROS1, KRAS2, TP53, and MYC. Examples of liver cancer related genes include Axin1, MALAT1, b-catenin, p16 INK4A, c-ERBB-2, p53, CTNNB1, RB1, Cyclin D1, SMAD2, EGFR, SMAD4, IGFR2, TCF1, and KRAS. Examples of kidney cancer related genes include Alpha, PRCC, ASPSCR1, PSF, CLTC, TFE3, p54nrb/NONO, and TFEB. Examples of thyroid cancer related genes include AKAP10, NTRK1, AKAP9, RET, BRAF, TFG, ELE1, TPM3, H4/D10S170, and TPR. Examples of ovarian cancer related genes include AKT2, MDM2, BCL2, MYC, BRCA1, NCOA4, CDKN2A, p53, ERBB2, PIK3CA, GATA4, RB, HRAS, RET, KRAS, and RNASET2. Examples of prostate cancer related genes include AR, KLK3, BRCA2, MYC, CDKN1B, NKX3.1, EZH2, p53, GSTP1, and PTEN. Examples of bone tumor related genes include CDH11, COL12A1, CNBP, OMD, COL1A1, THRAP3, COL4A5, and USP6.

In a preferred embodiment, the machine learning model is trained and used for classification of tissue types on the basis of whole slide images. Preferably, the machine learning model is trained and used for identification of gene mutations, such as BRAF mutations and/or NTRK fusions, as described in WO2020229152A1 and/or J. Hochne et al.: Detecting genetic alterations in BRAF and NTRK as oncogenic drivers in digital pathology images: towards model generalization within and across multiple thyroid cohorts, Proceedings of Machine Learning Research 156, 2021, pages 1-12, the contents of which are incorporated by reference in their entirety into this specification.

For example, the machine learning model can be trained to detect signs of the presence of oncogenic drivers in patient tissue images stained with hematoxylin and cosin.

F. Penault-Llorca et al. describe a testing algorithm for identification of patients with TRK fusion cancer (see J. Clin. Pathol., 2019, 72, 460-467). The algorithm comprises immunohistochemistry (IHC) studies, fluorescence in situ hybridization (FISH) and next-generation sequencing.

Immunohistochemistry provides a routine method to detect protein expression of NTRK genes. However, performing immunohistochemistry requires additional tissue section(s) and time to proceed and interpret (following hematoxylin and cosin initial staining based on which tumor diagnosis is performed), skills and the correlation between protein expression and gene fusion status is not trivial. Interpretation of IHC results requires the skills of a trained and certified medical professional pathologist.

Similar practical challenges hold true for other molecular assays such as FISH.

Next-generation sequencing provides a precise method to detect NTRK gene fusions. However, performing gene analyses for each patient is expensive, tissue consuming (not always feasible when available tissue specimen is minimal, as in diagnostic biopsies), not universally available in various geographic locations or diagnostic laboratories/healthcare institutions and, due to the low incidence of NTRK oncogenic fusions, inefficient.

There is therefore a need for a comparatively rapid and inexpensive method to detect signs of the presence of specific tumors.

It is proposed to train a machine learning model as described in this disclosure to assign histopathological images of tissues from patients to one of at least two classes, where one class comprises images showing tissue in which a specific gene mutation is present, such as NTRK or BRAF.

It is proposed to use the trained machine learning model as a preliminary test. Patients in whom the specific mutation can be detected are then subjected to a standard examination such as IHC, FISH and/or next-generation sequencing to verify the finding.

Additional studies may also be considered, such as other forms of medical imaging (CT scans, MRI, etc.) that can be co-assessed using AI to generate multimodal biomarkers/characteristics for diagnostic purposes.

The machine learning model of the present disclosure can, e.g., be used to
a) detect NTRK fusion events in one or more indications,
b) detect NTRK fusion events in other indications than in those being trained on (i.e., an algorithm trained on thyroid data sets is useful in lung cancer data sets),
c) detect NTRK fusion events involving other TRK family members (i.e., an algorithm trained on NTRK1, NTRK3 fusions is useful to predict also NTRK2 fusions),
d) detect NTRK fusion events involving other fusion partners (i.e., an algorithm trained on LMNA-fusion data sets is useful also in TPM3-fusion data sets),
c) discover novel fusion partners (i.e., an algorithm trained on known fusion events might predict a fusion in a new data set which is then confirmed via molecular assay to involve a not yet described fusion partner of a NTRK family member),
f) catalyze the diagnostic workflow and clinical management of patients offering a rapid, tissue-sparing, low-cost method to indicate the presence of NTRK-fusions (and ultimately others) and identifying patients that merit further downstream molecular profiling so as to provide precision medicines targeting specific molecular aberrations (e.g. NTRK-fusion inhibitors),
g) identify specific genetic aberrations based on histological specimen can additionally be used to confirm/exclude or re-label certain tumor diagnosis, in cases the presence or absence of this/these alterations(s) is pathognomonic of specific tumors.

Identification of specific genetic aberrations based on histological specimen can additionally be used to confirm/exclude or re-label certain tumor diagnosis, in cases the presence or absence of this/these alterations(s) is pathognomonic of specific tumors.

Histopathological images used for training and prediction of the machine learning model can be obtained from patients by biopsy or surgical resection specimens.

In a preferred embodiment, a histopathological image is a microscopic image of tumor tissue of a human patient. The magnification factor is preferably in the range of 10 to 60, more preferably in the range of 20 to 40, whereas a magnification factor of, e.g., “20” means that a distance of 0.05 mm in the tumor tissue corresponds to a distance of 1 mm in the image (0.05 mm×20=1 mm).

In a preferred embodiment, the histopathological image is a whole-slide image.

In a preferred embodiment, the histopathological image is an image of a stained tumor tissue sample. One or more dyes can be used to create the stained images. Preferred dyes are hematoxylin and/or cosin.

Methods for creating histopathological images, in particular stained whole-slide microscopy images, are extensively described in scientific literature and textbooks (see e.g. S. K. Suvarna et al.: Bancroft's Theory and Practice of Histological Techniques, 8^{th} Ed., Elsevier 2019, ISBN 978-0-7020-6864-5; A. F. Frangi et al.: Medical Image Computing and Computer Assisted Intervention—MICCAI 2018, 21^{st} International Conference Granada, Spain, 2018 Proceedings, Part II, ISBN 978-030-00933-5; L. C. Junqueira et al.: Histologie, Springer 2001, ISBN: 978-354-041858-0; N. Coudray et al.: Classification and mutation prediction from non-small cell lung cancer histopathology images using deep learning, Nature Medicine, Vol. 24, 2018, pages 1559-1567).

The machine learning model can also be configured to generate a probability value, the probability value indicating the probability of a patient suffering from cancer, e.g., caused by an NTRK oncogenic fusion. The probability value can be outputted to a user and/or stored in a database. The probability value can be a real number in the range from 0 to 1, whereas a probability value of 0 usually means that it is impossible that the cancer is caused by an NTRK oncogenic fusion, and a probability value of 1 usually means that there is no doubt that the cancer is caused by an NTRK oncogenic fusion. The probability value can also be expressed by a percentage.

In a preferred embodiment of the present invention, the probability value is compared with a predefined threshold value. In the event the probability value is lower than the threshold value, the probability that the patient suffers from cancer caused by an NTRK oncogenic fusion is low; treating the patient with a Trk inhibitor is not indicated; further investigations are required in order to determine the cause of cancer. In the event the probability value equals the threshold value or is greater than the threshold value, it is reasonable to assume that the cancer is caused by an NTRK oncogenic fusion; the treatment of the patient with a Trk inhibitor can be indicated; further investigations to verify the assumption can be initiated (e.g., performing a genetic analysis of the tumor tissue).

The threshold value can be a value between 0.5 and 0.99999999999, e.g. 0.8 (80%) or 0.81 (81%) or 0.82 (82%) or 0.83 (83%) or 0.84 (84%) or 0.85 (85%) or 0.86 (86%) or 0.87 (87%) or 0.88 (88%) or 0.89 (89%) or 0.9 (90%) or 0.91 (91%) or 0.92 (92%) or 0.93 (93%) or 0.94 (94%) or 0.95 (95%) or 0.96 (96%) or 0.97 (97%) or 0.98 (98%) or 0.99 (99%) or any other value (percentage). The threshold value can be determined by a medical expert.

Besides a histopathological image, additional patient data can also be included in the classification. Additional patient data can be, e.g., anatomic or physiology data of the patient, such as information about patient's height and weight, gender, age, vital parameters (such as blood pressure, breathing frequency and heart rate), tumor grades, ICD-9 classification, oxygenation of tumor, degree of metastasis of tumor, blood count value tumor indicator value like PA value, information about the tissue the histopathological image is created from (e.g. tissue type, organ), further symptoms, medical history etc. Also, the pathology report of the histopathological images can be used for classification, using text mining approaches. Also, a next generation sequencing raw data set which does not cover the TRK genes' sequences can be used for classification.

Further embodiments of the present disclosure include:

1. A computer-implemented method of classifying an image of a tissue, the method comprising:
providing a trained machine learning model,
   wherein the trained machine-learning model is configured and was trained on training data
      to receive a number of patches generated from an image of a tissue,
      to generate a patch embedding for each received patch,
      to aggregate patch embeddings into a bag-level representation, with each patch embedding assigned a learnable attention weight, and
      to classify the bag-level representation into one of at least two classes,
receiving a new image of a tissue,
generating a multitude of patches from the new image,
inputting the patches into the trained machine-learning model,
receiving from the trained machine learning model a first classification result, the first classification result comprising, for each patch inputted into the trained machine-learning model, an attention weight assigned to the patch embedding of the patch,
selecting a number of patches based on the attention weights,
inputting the selected patches and/or patches of regions comprising one or more selected patches into the trained machine learning model,
receiving from the trained machine learning model a second classification result, wherein the second classification result comprises information about which class of the two classes the new image was assigned to,
outputting the second classification result and/or storing the second classification result in a data memory and/or transmitting the second classification result to a separate computer system.
   2. A computer-implemented method of classifying an image of a tissue,
providing a trained machine learning model,
   wherein the trained machine-learning model is configured and was trained on training data
      to receive a number of patches generated from an image of a tissue,
      to generate a patch embedding for each received patch,
      to aggregate patch embeddings into a bag-level representation, with each patch embedding assigned a learnable attention weight, and
      to classify the bag-level representation into one of at least two classes,
receiving a new image of a tissue,
generating a multitude of patches from the new image,
inputting the patches into the trained machine-learning model,
receiving from the trained machine learning model a first classification result, the first classification result comprising, for each patch inputted into the trained machine-learning model, an attention weight assigned to the patch embedding of the patch,
determining a proportion or number of patches whose patch embeddings have an attention weight that is above a predefined first threshold,
in case the proportion or the number of patches is below a predefined second threshold:
selecting a number of patches based on the attention weights,
   inputting the selected patches and/or patches of regions comprising one or more selected patches into the trained machine learning model,
   receiving from the trained machine learning model a second classification result, wherein the second classification result comprises information about which class of the two classes the new image was assigned to,
outputting the second classification result and/or storing the second classification result in a data memory and/or transmitting the second classification result to a separate computer system.
   3. The method of embodiment 1 or 2, wherein the new image is a whole slide histopathological image of a tissue of a human body.
   4. The method of embodiment 1 or 2, wherein the new image is a radiological image, preferably a computed tomography image or a magnetic resonance imaging image.
   5. The method of embodiment 4, wherein each patch is a slice of the radiological image.
   6. The method of any one of the embodiments 1 to 5, wherein the trained machine learning model is or comprises a convolutional neural network.
   7. The method of any one of the embodiments 1 to 6, wherein the trained machine learning model is or comprises a transformer network.
   8. The method of any one of the embodiments 1 to 7,
   wherein generating a multitude of patches from the new image comprises:
dividing the new image into a number q of patches,
   wherein inputting the patches into the trained machine-learning model comprises:
inputting the number q of patches into the trained machine-learning model.
   9. The method of any one of the embodiments 1 to 8,
   wherein selecting a number of patches based on the attention weights comprises:
ranking the patches according to the size of the attention weights of their patch embeddings and selecting from this ranking a number m of patches with the highest attention weights.
   10. The method of any one of the embodiments 1 to 9,
   wherein selecting a number of patches based on the attention weights comprises:
splitting the patches into two groups, a first group and a second group, wherein the patch embedding of each patch in the first group has a higher attention weighting than the patch embedding of each patch in the second group,
selecting the patches in the first group.
   11. The method of any one of the embodiments 1 to 10,
   wherein selecting a number of patches based on the attention weights comprises:
selecting those patches with a higher probability whose patch embeddings have a higher attention weight.
   12. The method of any one of the embodiments 1 to 11,
   wherein selecting a number of patches based on the attention weights comprises:
selecting those patches for which the attention weights of their patch embeddings are above a pre-defined threshold.
   13. The method of any one of the embodiments 1 to 12,
   wherein selecting a number of patches based on the attention weights comprises:
selecting patches that have a predefined proximity in the new image to a patch whose patch embedding has an attention weight that is above a predefined threshold.
   14. The method of any one of the embodiments 1 to 14, wherein one class represents images showing a diseased tissue.
   15. A computer system comprising:
a processor; and
a memory storing an application program configured to perform, when executed by the processor, an operation, the operation comprising:
   providing a trained machine learning model,
      wherein the trained machine-learning model is configured and was trained on training data
         to receive a number of patches generated from an image of a tissue,
         to generate a patch embedding for each received patch,
         to aggregate patch embeddings into a bag-level representation, with each patch embedding assigned a learnable attention weight, and
         to classify the bag-level representation into one of at least two classes,
   receiving a new image of a tissue,
   generating a multitude of patches from the new image,
   inputting the patches into the trained machine-learning model,
   receiving from the trained machine learning model a first classification result, the first classification result comprising, for each patch inputted into the trained machine-learning model, an attention weight assigned to the patch embedding of the patch,
   selecting a number of patches based on the attention weights,
   inputting the selected patches and/or patches of regions comprising one or more selected patches into the trained machine learning model,
   receiving from the trained machine learning model a second classification result, wherein the second classification result comprises information about which class of the two classes the new image was assigned to,
   outputting the second classification result and/or storing the second classification result in a data memory and/or transmitting the second classification result to a separate computer system.
      16. A non-transitory computer readable medium having stored thereon software instructions that, when executed by a processor of a computer system, cause the computer system to execute the following steps:
providing a trained machine learning model,
   wherein the trained machine-learning model is configured and was trained on training data
      to receive a number of patches generated from an image of a tissue,
      to generate a patch embedding for each received patch,
      to aggregate patch embeddings into a bag-level representation, with each patch embedding assigned a learnable attention weight, and
      to classify the bag-level representation into one of at least two classes,
receiving a new image of a tissue,
generating a multitude of patches from the new image,
inputting the patches into the trained machine-learning model,
receiving from the trained machine learning model a first classification result, the first classification result comprising, for each patch inputted into the trained machine-learning model, an attention weight assigned to the patch embedding of the patch,
selecting a number of patches based on the attention weights,
inputting the selected patches and/or patches of regions comprising one or more selected patches into the trained machine learning model,
receiving from the trained machine learning model a second classification result, wherein the second classification result comprises information about which class of the two classes the new image was assigned to,
   outputting the second classification result and/or storing the second classification result in a data memory and/or transmitting the second classification result to a separate computer system.

The invention is explained in more detail below with reference to the drawings, without wishing to limit the invention to the features and combinations of features shown in the drawings.

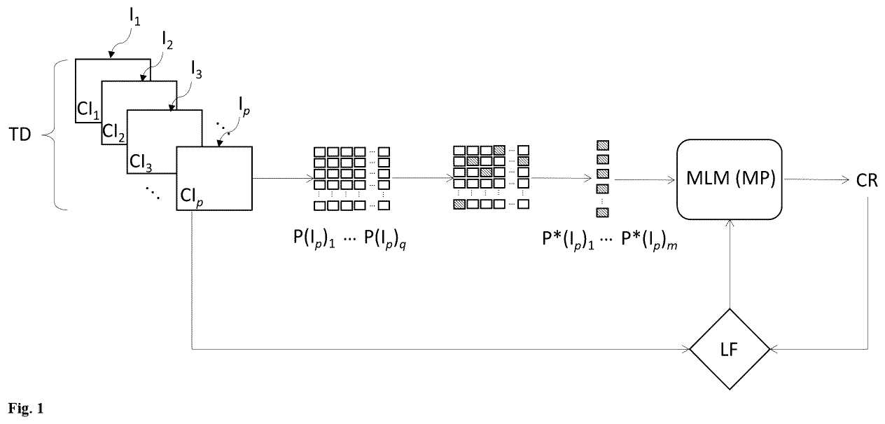

FIG. 1 schematically shows an embodiment of the method for training the machine learning model of the present disclosure. Training is performed on the basis of training data TD. The training data TD comprise a plurality of images I1, I2, I3, . . . , Ip. Each image shows a tissue. Each image I1, I2, I3, . . . , Ip carries a label CI1, CI2, CI3, . . . , CIp indicating to which class of at least two classes the image is assigned. This label is also referred to as class information in this disclosure. The assignment may have been made by an expert, e.g., a health practitioner.

From each image a number of patches is generated. This is shown in FIG. 1 only for the image Ip: the image Ip is divided into a number q of patches P(Iₚ)₁, . . . , P(Iₚ)_{q}. From the number q of patches, a number m of patches P*(Iₚ)₁, . . . , P*(Iₚ)ₘ is selected. m is less than or equal to q. Patches can be selected randomly, for example. The selected patches P*(Iₚ)₁, . . . , P*(Iₚ)ₘ are shown hatched in FIG. 1. The selected patches P*(Iₚ)₁, . . . , P*(Iₚ)ₘ are inputted into the machine learning model MLM. The machine learning model MLM is configured to assign the selected patches P*(Iₚ)₁, . . . , P*(Iₚ)ₘ (to be more precise: a bag-level representation of patch embeddings of the selected patches) to one of two classes based on the model parameters MP. The machine learning model MLM outputs a classification result CR containing information about which of the at least two classes the machine learning model MLM assigned the selected patches to. The classification result CR is compared with the class information CIₚ. A loss function LF is used to quantify one or more deviations between the classification result CR and the class information CIₚ. The one or more deviations are reduced by modifying the model parameters MP, e.g., in an optimization procedure, such as a gradient descent optimization procedure. The process is repeated for further images and/or further selected patches.

The training can be terminated if one or more stop criteria are met. Such stop criteria can be for example: a predefined maximum number of training steps has been performed, the one or more deviations can no longer be reduced by modifying model parameters, a predefined minimum of the loss function is reached, and/or an extreme value (e.g., maximum or minimum) of another performance value is reached.

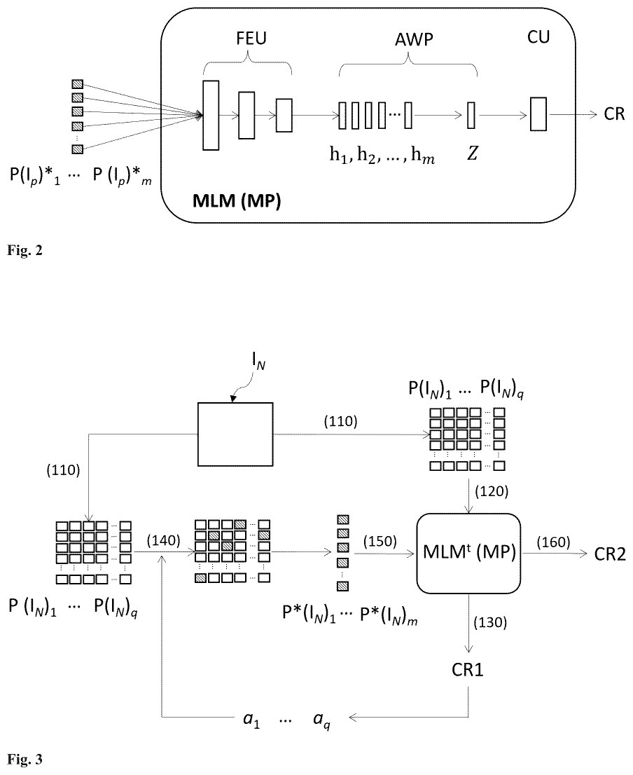

FIG. 2 schematically shows an embodiment of the machine learning model of the present disclosure in more detail. The machine learning model MLM is configured to receive (selected) patches P*(Iₚ)₁, . . . , P*(Iₚ)ₘ and to output a classification result CR. For each (selected) patch P*(Iₚ)₁, . . . , P*(Iₚ)ₘ a patch embedding h₁, h₂, . . . , hₘ is generated by a feature extraction unit FEU, such as a convolutional neural network. The patch embeddings h₁, h₂, . . . , hₘ are aggregated into a bag-level representation Z using an attention weighted pooling AWP. The bag-level representation Z is fed into a classification unit CU and the classification unit CU is configured to classify the bag-level representation Z into one of at least two classes and to output the classification result CR.

FIG. 3 schematically shows an embodiment of the method of classifying a new image into one of at least two classes using the trained machine learning model of the present disclosure.

In a first step (110), a number q of patches P(I_{N})₁, . . . , P(I_{N})_{q} is generated from the new image I_{N}. In a further step (120), the generated patches P(I_{N})₁, . . . , P(I_{N})_{q} are inputted into the trained machine learning model MLM^{t}. In the embodiment shown in FIG. 3, all patches P(I_{N})₁, . . . , P(I_{N})_{q} are inputted into the trained machine learning model MLM^{t}; however, it is also possible to input only a portion of the generated patches into the trained machine learning model MLM^{t}. In a further step (130), the trained machine learning model MLM^{t} generates a first classification result CR1. The first classification result CRI includes information about the attention weights a₁, . . . , a_{q} assigned to the patch embeddings of the input patches by the trained machine learning model MLM^{t}. These attention weights a₁, . . . , a_{q} are used in a further step (140) to select patches. Thus, from the originally generated patches P(I_{N})₁, . . . , P(I_{N})_{q}, a number m of patches P*(I_{N})₁, . . . , P*(I_{N})ₘ are selected. A patch is usually selected with a higher probability the higher the attention weight of the corresponding patch embedding (not explicitly shown in FIG. 3). In a further step (150), the selected patches P*(I_{N})₁, . . . , P*(I_{N}), are fed to the trained machine learning model MLM^{t}. In a further step (160), the trained machine learning model MLM^{t} generates a second classification result CR2. The second classification result CR2 indicates to which class of at least two classes the trained machine learning model MLM^{t} has assigned the new image I_{N}(more precisely the selected patches P*(I_{N})₁, . . . , P*(I_{N}), representing the new image I_{N}).

FIG. 4 shows an embodiment of the computer-implemented method of the present disclosure in the form of a flow chart. The method (100) comprises the steps:

(110) providing a trained machine learning model, wherein the trained machine-learning model is configured and was trained on training data
to receive a number of patches generated from an image of a tissue,
to generate a patch embedding for each received patch,
to aggregate patch embeddings into a bag-level representation, with each patch embedding assigned a learnable attention weight, and
to classify the image into one of at least two classes based on the bag-level representation,
   (120) receiving a new image of a tissue,
   (130) generating a multitude of patches from the new image,
   (140) inputting the patches generated from the new image into the trained machine-learning model,
   (150) receiving from the trained machine learning model a first classification result, the first classification result comprising, for each patch inputted into the trained machine-learning model, an attention weight assigned to the patch embedding of the patch,
   (160) selecting a number of patches based on the attention weights,
   (170) inputting the selected patches and/or patches of regions comprising one or more selected patches into the trained machine learning model,
   (180) receiving from the trained machine learning model a second classification result, wherein the second classification result comprises information about which class of the two classes the new image was assigned to,
   (190) outputting the second classification result and/or storing the second classification result in a data memory and/or transmitting the second classification result to a separate computer system.

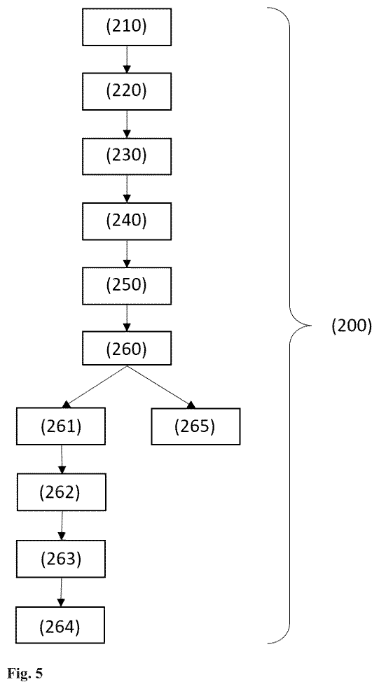

FIG. 5 shows another embodiment of the computer-implemented method of the present disclosure in the form of a flow chart. The method (200) comprises the steps:

(210) providing a trained machine learning model, wherein the trained machine-learning model is configured and was trained on training data
to receive a number of patches generated from an image of a tissue,
to generate a patch embedding for each received patch,
to aggregate patch embeddings into a bag-level representation, with each patch embedding assigned a learnable attention weight, and
to classify the image into one of at least two classes based on the bag-level representation,
   (220) receiving a new image of a tissue,
   (230) generating a multitude of patches from the new image,
   (240) inputting the patches into the trained machine-learning model,
   (250) receiving from the trained machine learning model a first classification result, the first classification result comprising, (i) for each patch inputted into the trained machine-learning model, an attention weight assigned to the patch embedding of the patch, (ii) information about which class of the two classes the new image was assigned to,
   (260) determining a proportion or number of patches whose patch embeddings have an attention weight that is above a predefined first threshold,
in case the proportion or the number of patches is below a predefined second threshold:
   (261) selecting a number of patches based on the attention weights,
   (262) inputting the selected patches and/or patches of regions comprising one or more selected patches into the trained machine learning model,
   (263) receiving from the trained machine learning model a second classification result, wherein the second classification result comprises information about which class of the two classes the new image was assigned to,
   (264) outputting the second classification result and/or storing the second classification result in a data memory and/or transmitting the second classification result to a separate computer system.
in case the proportion or the number of patches is equal to or greater than the predefined second threshold:
   (265) outputting the first classification result and/or storing the first classification result in a data memory and/or transmitting the first classification result to a separate computer system.

The operations in accordance with the teachings herein may be performed by at least one computer specially constructed for the desired purposes or general purpose computer specially configured for the desired purpose by at least one computer program stored in a typically non-transitory computer readable storage medium.

The term “non-transitory” is used herein to exclude transitory, propagating signals or waves, but to otherwise include any volatile or non-volatile computer memory technology suitable to the application.

The term “computer” should be broadly construed to cover any kind of electronic device with data processing capabilities, including, by way of non-limiting example, personal computers, servers, embedded cores, computing system, communication devices, processors (e.g., digital signal processor (DSP)), microcontrollers, field programmable gate array (FPGA), application specific integrated circuit (ASIC), etc.) and other electronic computing devices.

The term “process” as used above is intended to include any type of computation or manipulation or transformation of data represented as physical, e.g., electronic, phenomena which may occur or reside e.g., within registers and/or memories of at least one computer or processor. The term processor includes a single processing unit or a plurality of distributed or remote such units.

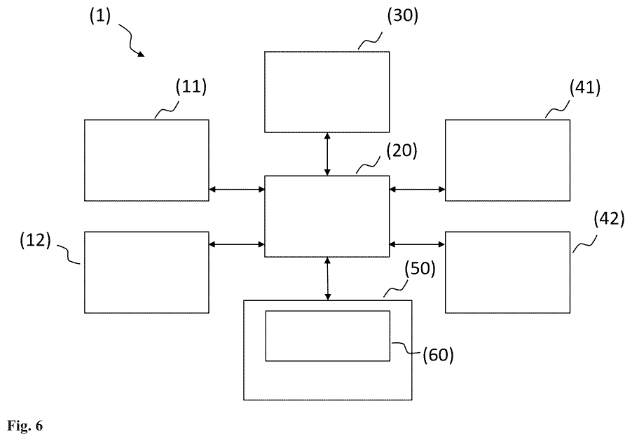

FIG. 6 illustrates a computer system (1) according to some example implementations of the present disclosure in more detail. The computer may include one or more of each of a number of components such as, for example, processing unit (20) connected to a memory (50) (e.g., storage device).

The processing unit (20) may be composed of one or more processors alone or in combination with one or more memories. The processing unit is generally any piece of computer hardware that is capable of processing information such as, for example, data, computer programs and/or other suitable electronic information. The processing unit is composed of a collection of electronic circuits some of which may be packaged as an integrated circuit or multiple interconnected integrated circuits (an integrated circuit at times more commonly referred to as a “chip”). The processing unit may be configured to execute computer programs, which may be stored onboard the processing unit or otherwise stored in the memory (50) of the same or another computer.

The processing unit (20) may be a number of processors, a multi-core processor or some other type of processor, depending on the particular implementation. Further, the processing unit may be implemented using a number of heterogeneous processor systems in which a main processor is present with one or more secondary processors on a single chip. As another illustrative example, the processing unit may be a symmetric multi-processor system containing multiple processors of the same type. In yet another example, the processing unit may be embodied as or otherwise include one or more ASICs, FPGAs or the like. Thus, although the processing unit may be capable of executing a computer program to perform one or more functions, the processing unit of various examples may be capable of performing one or more functions without the aid of a computer program. In either instance, the processing unit may be appropriately programmed to perform functions or operations according to example implementations of the present disclosure.

The memory (50) is generally any piece of computer hardware that is capable of storing information such as, for example, data, computer programs (e.g., computer-readable program code (60)) and/or other suitable information cither on a temporary basis and/or a permanent basis. The memory may include volatile and/or non-volatile memory and may be fixed or removable. Examples of suitable memory include random access memory (RAM), read-only memory (ROM), a hard drive, a flash memory, a thumb drive, a removable computer diskette, an optical disk, a magnetic tape or some combination of the above. Optical disks may include compact disk-read only memory (CD-ROM), compact disk-read/write (CD-R/W), DVD, Blu-ray disk or the like. In various instances, the memory may be referred to as a computer-readable storage medium. The computer-readable storage medium is a non-transitory device capable of storing information and is distinguishable from computer-readable transmission media such as electronic transitory signals capable of carrying information from one location to another. Computer-readable medium as described herein may generally refer to a computer-readable storage medium or computer-readable transmission medium.

In addition to the memory (50), the processing unit (20) may also be connected to one or more interfaces for displaying, transmitting and/or receiving information. The interfaces may include one or more communications interfaces and/or one or more user interfaces. The communications interface(s) may be configured to transmit and/or receive information, such as to and/or from other computer(s), network(s), database(s) or the like. The communications interface may be configured to transmit and/or receive information by physical (wired) and/or wireless communications links. The communications interface(s) may include interface(s) (41) to connect to a network, such as using technologies such as cellular telephone, Wi-Fi, satellite, cable, digital subscriber line (DSL), fiber optics and the like. In some examples, the communications interface(s) may include one or more short-range communications interfaces (42) configured to connect devices using short-range communications technologies such as NFC, RFID, Bluetooth, Bluetooth LE, ZigBee, infrared (e.g., IrDA) or the like.

The user interfaces may include a display (30). The display may be configured to present or otherwise display information to a user, suitable examples of which include a liquid crystal display (LCD), light-emitting diode display (LED), plasma display panel (PDP) or the like. The user input interface(s) (11) may be wired or wireless and may be configured to receive information from a user into the computer system (1), such as for processing, storage and/or display. Suitable examples of user input interfaces include a microphone, image or video capture device, keyboard or keypad, joystick, touch-sensitive surface (separate from or integrated into a touchscreen) or the like. In some examples, the user interfaces may include automatic identification and data capture (AIDC) technology (12) for machine-readable information. This may include barcode, radio frequency identification (RFID), magnetic stripes, optical character recognition (OCR), integrated circuit card (ICC), and the like. The user interfaces may further include one or more interfaces for communicating with peripherals such as printers and the like.

As indicated above, program code instructions may be stored in memory, and executed by processing unit that is thereby programmed, to implement functions of the systems, subsystems, tools and their respective elements described herein. As will be appreciated, any suitable program code instructions may be loaded onto a computer or other programmable apparatus from a computer-readable storage medium to produce a particular machine, such that the particular machine becomes a means for implementing the functions specified herein. These program code instructions may also be stored in a computer-readable storage medium that can direct a computer, processing unit or other programmable apparatus to function in a particular manner to thereby generate a particular machine or particular article of manufacture. The instructions stored in the computer-readable storage medium may produce an article of manufacture, where the article of manufacture becomes a means for implementing functions described herein. The program code instructions may be retrieved from a computer-readable storage medium and loaded into a computer, processing unit or other programmable apparatus to configure the computer, processing unit or other programmable apparatus to execute operations to be performed on or by the computer, processing unit or other programmable apparatus.

Retrieval, loading and execution of the program code instructions may be performed sequentially such that one instruction is retrieved, loaded and executed at a time. In some example implementations, retrieval, loading and/or execution may be performed in parallel such that multiple instructions are retrieved, loaded, and/or executed together. Execution of the program code instructions may produce a computer-implemented process such that the instructions executed by the computer, processing circuitry or other programmable apparatus provide operations for implementing functions described herein.

Execution of instructions by processing unit, or storage of instructions in a computer-readable storage medium, supports combinations of operations for performing the specified functions. In this manner, a computer system (1) may include processing unit (20) and a computer-readable storage medium or memory (50) coupled to the processing circuitry, where the processing circuitry is configured to execute computer-readable program code (60) stored in the memory. It will also be understood that one or more functions, and combinations of functions, may be implemented by special purpose hardware-based computer systems and/or processing circuitry which perform the specified functions, or combinations of special purpose hardware and program code instructions.

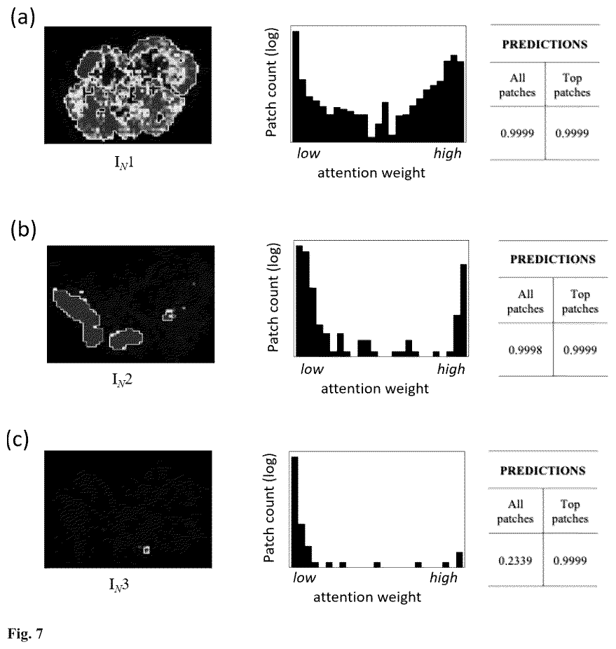

FIG. 7 shows the results of six classifications using the trained machine learning model of the present disclosure. The machine learning model was trained to distinguish breast tissue affected by breast cancer from healthy breast tissue using training data. The machine learning model was trained to assign images of breast tissue to one of two classes, one class representing images in which only healthy breast tissue is shown, and the other class representing images in which (among other things) breast tissue affected by breast cancer is shown.

FIG. 7 (a) shows the result of two classifications of image IN1 using the trained machine learning model. FIG. 7 (b) shows the result of two classifications of image IN2 using the trained machine learning model. FIG. 7 (c) shows the result of two classifications of image IN3 using the trained machine learning model.

In case of image I_{N}1 (FIG. 7 (a)), a large part of the breast tissue is affected by breast cancer; in case of image I_{N}2 (FIG. 7 (b)), only a medium part of the breast tissue is affected by breast cancer; in case of image I_{N}3 (FIG. 7 (c)), only a very small part of the breast tissue is affected by breast cancer.

Each image was divided into a number of patches. For each image, two classifications were performed; a first classification based on all patches and a second classification based on patches selected based on the attention weights of their patch embeddings. The middle column shows how the attention weights are distributed. On the x-axis (attention weight), the attention weights are plotted in ascending order (from left to right), i.e., low attention weights are located on the left and high attention weights are located on the right. On the y-axis (Patch count), the number of patches whose patch embedding was assigned a corresponding attention weight is shown in logarithmic form.

The right column shows the results of the two classifications for each image. The numbers reflect the accuracy of the classification result: the higher the number, the more trustworthy the classification result.

It can be seen that in the present example, for images IN1 and IN2, it makes no difference whether the classification is based on all patches or only on the selected patches (Top patches). However, in the case of image I_{N}3, the difference between the classification results is enormous. This shows that the invention is particularly suitable and advantageous for the classification of such images where only a small part of the image is relevant for the classification result.

Usually, a user does not know which parts of an image are relevant for a classification result. Therefore, the method according to the invention can always be applied (to be on the safe side).

However, it is also conceivable that the approach according to the present disclosure is only used if the first classification result shows that only a small number of patches is relevant for the classification result. If the number of patches having a predefined relevance to a classification result (e.g., an attention weight that is above a threshold) is below a predefined threshold, the method according to the invention is used and a second classification result is generated. Otherwise, the first classification result is outputted. The threshold values can be determined empirically.

A variation of the approach according to the present disclosure therefore comprises the steps:
providing a trained machine learning model, wherein the trained machine-learning model is configured and was trained on training data
   to receive a number of patches generated from an image of a tissue,
   to generate a patch embedding for each received patch,
   to aggregate patch embeddings into a bag-level representation, with each patch embedding assigned a learnable attention weight, and
   to classify the image into one of at least two classes based on the bag-level representation,
receiving a new image of a tissue,
generating a multitude of patches from the new image,
inputting the patches into the trained machine-learning model,
receiving from the trained machine learning model a first classification result, the first classification result comprising, for each patch inputted into the trained machine-learning model, an attention weight assigned to the patch embedding of the patch, determining a proportion or number of patches whose patch embeddings have an attention weight that is above a predefined first threshold,
in case the proportion or the number of patches is below a predefined second threshold:
   selecting a number of patches based on the attention weights,
   inputting the selected patches and/or patches of regions comprising one or more selected patches into the trained machine learning model,
   receiving from the trained machine learning model a second classification result, wherein the second classification result comprises information about which class of the two classes the new image was assigned to,
   outputting the second classification result and/or storing the second classification result in a data memory and/or transmitting the second classification result to a separate computer system.

1. A computer-implemented method comprising:
providing a trained machine learning model (MLM^{t}), wherein the trained machine-learning model (MLM^{t}) is configured and was trained on training data (TD) to:
receive a number of patches (P*(Iₚ)₁, . . . , P(Iₚ)*ₘ) generated from an image (Iₚ) of a tissue,
to generate a patch embedding (h₁, h₂, . . . , hₘ) for each received patch (P*(Iₚ)₁, . . . , P*(I_{N})ₘ),
to aggregate patch embeddings (h₁, h₂, . . . , hₘ) into a bag-level representation (Z), with each patch embedding (h₁, h₂, . . . , hₘ) assigned a learnable attention weight (a₁, . . . , aₘ), and
to classify the image (Iₚ) into one of at least two classes based on the bag-level representation (Z);
receiving a new image (I_{N}) of a tissue;
generating a multitude of patches (P(I_{N})₁, . . . , P(I_{N})_{q}) from the new image (I_{N});
inputting the patches (P(I_{N})₁, . . . , P(I_{N})_{q}) generated from the new image (I_{N}) into the trained machine-learning model (MLM^{t});
receiving from the trained machine learning model (MLM^{t}) a first classification result (CR1), the first classification result (CR1) comprising, for each patch (P(I_{N})₁, . . . , P(I_{N})_{q}) inputted into the trained machine-learning model (MLM^{t}), an attention weight (a₁, . . . , a_{q}) assigned to the patch embedding (h₁, h₂, . . . , h_{q}) of the patch (P(I_{N})₁, . . . , P(I_{N})_{q});
selecting a number of patches (P*(I_{N})₁, . . . , P*(I_{N})ₘ) based on the attention weights (a₁, . . . , a_{q});
inputting the selected patches (P*(I_{N})₁, . . . , P*(I_{N})ₘ) and/or patches of regions comprising one or more selected patches (P*(I_{N})₁, . . . , P*(I_{N})ₘ) into the trained machine learning model (MLM^{t});
receiving from the trained machine learning model (MLM^{t}) a second classification result (CR2), wherein the second classification result (CR2) comprises information about which class of the two classes the new image (I_{N}) was assigned to; and
outputting the second classification result (CR2) and/or storing the second classification result (CR2) in a data memory and/or transmitting the second classification result (CR2) to a separate computer system.

2. The method of claim 1, further comprising:
determining a proportion or number of patches whose patch embeddings have an attention weight that is above a predefined first threshold; and
if the proportion or the number of patches is below a predefined second threshold:
selecting a number of patches (P*(I_{N})₁, . . . , P*(I_{N})ₘ) based on the attention weights (a₁, . . . , a_{q}),
inputting the patches (P(I_{N})₁, . . . , P(I_{N})_{q}) generated from the new image (I_{N}) into the trained machine-learning model (MLM^{t}),
receiving from the trained machine learning model (MLM^{t}) a second classification result (CR2), wherein the second classification result (CR2) comprises information about which class of the two classes the new image (I_{N}) was assigned to, and
outputting the second classification result (CR2) and/or storing the second classification result (CR2) in a data memory and/or transmitting the second classification result (CR2) to a separate computer system.

3. The method of claim 1, wherein inputting the selected patches (P*(I_{N})₁, . . . , P*(I_{N})ₘ) and/or patches of regions comprising one or more selected patches (P*(I_{N})₁, . . . , P*(I_{N})ₘ) into the trained machine learning model (MLM^{t}) comprises inputting further patches of regions comprising one or more selected patches (P*(I_{N})₁, . . . , P*(I_{N})ₘ) into the trained machine learning model (MLM^{t}).

4. The method of claim 1, further comprising:
selecting patches (P*(I_{N})₁, . . . , P*(I_{N})ₘ) from those regions that have the most patches with the highest patch embedding attention weights.

5. The method of claim 1, further comprising:
selecting patches (P*(I_{N})₁, . . . , P*(I_{N})ₘ) from those regions that have the most patches with patch embedding attention weights above a predefined threshold.

6. The method of claim 1, further comprising:
selecting further patches that have a defined spatial proximity to one or more selected patches.

7. The method of claim 1, wherein selecting a number of patches (P*(I_{N})₁, . . . , P*(I_{N})ₘ) based on the attention weights (a₁, . . . , a_{q}) comprises selecting patches (P*(I_{N})₁, . . . , P*(I_{N})ₘ) that have a predefined proximity in the new image (I_{N}) to a patch whose patch embedding has an attention weight that is above a predefined threshold.

8. The method of claim 1, wherein the new image (I_{N}) is a whole slide histopathological image of a tissue of a human body.

9. The method of claim 1, wherein the new image (I_{N}) is a radiological image.

10. The method of claim 1, wherein the trained machine learning model (MLM^{t}) comprises a transformer network.

11. The method of claim 1, wherein one class of the at least two classes represents images showing a diseased tissue.

12. The method of claim 1, wherein one class of the at least two classes represents images showing cancerous tissue.

13. The method of claim 1, wherein one class of the at least two classes represents images showing cancerous tissue caused by a gene mutation.

14. A computer system comprising:
a processor; and
a memory storing an application program configured to perform, when executed by the processor, an operation comprising:
providing a trained machine learning model (MLM^{t}), wherein the trained machine-learning model (MLM^{t}) is configured and was trained on training data to:
receive a number of patches (P*(Iₚ)₁, . . . , P(Iₚ)*ₘ) generated from an image (Iₚ) of a tissue;
generate a patch embedding (h₁, h₂, . . . , hₘ) for each received patch (P*(Iₚ)₁, . . . , P*(I_{N})ₘ);
aggregate patch embeddings (h₁, h₂, . . . , hₘ) into a bag-level representation (Z), with each patch embedding (h₁, h₂, . . . , hₘ) assigned a learnable attention weight (a₁, . . . , aₘ); and
classify the image (Iₚ) into one of at least two classes based on the bag-level representation (Z),
receiving a new image (I_{N}) of a tissue,
generating a multitude of patches (P(I_{N})₁, . . . , P(I_{N})_{q}) from the new image (I_{N}),
inputting the patches (P(I_{N})₁, . . . , P(I_{N})_{q}) generated from the new image (I_{N}) into the trained machine-learning model (MLM^{t}),
receiving from the trained machine learning model (MLM^{t}) a first classification result (CR1), the first classification result (CR1) comprising, for each patch (P(I_{N})₁, . . . , P(I_{N})_{q}) inputted into the trained machine-learning model (MLM^{t}), an attention weight (a₁, . . . , a_{q}) assigned to the patch embedding (h₁, h₂, . . . , h_{q}) of the patch (P(I_{N})₁, . . . , P(I_{N})_{q}),
selecting a number of patches (P*(I_{N})₁, . . . , P*(I_{N})ₘ) based on the attention weights (a₁, . . . , a_{q}),
inputting the selected patches (P*(I_{N})₁, . . . , P*(I_{N})ₘ) and/or patches of regions comprising one or more selected patches (P*(I_{N})₁, . . . , P*(I_{N})ₘ) into the trained machine learning model (MLM^{t}),
receiving from the trained machine learning model (MLM^{t}) a second classification result (CR2), wherein the second classification result (CR2) comprises information about which class of the two classes the new image (I_{N}) was assigned to, and
outputting the second classification result (CR2) and/or storing the second classification result (CR2) in a data memory and/or transmitting the second classification result (CR2) to a separate computer system.

15. A non-transitory computer readable medium storing software instructions that, when executed by a processor of a computer system, cause the computer system to:
provide a trained machine learning model (MLM^{t}), wherein the trained machine-learning model (MLM^{t}) is configured and was trained on training data (TD) to:
receive a number of patches (P*(Iₚ)₁, . . . , P(Iₚ)*ₘ) generated from an image (Iₚ) of a tissue,
generate a patch embedding (h₁, h₂, . . . , hₘ) for each received patch (P*(Iₚ)₁, . . . , P*(I_{N})ₘ),
aggregate patch embeddings (h₁, h₂, . . . , hₘ) into a bag-level representation (Z), with each patch embedding (h₁, h₂, . . . , hₘ) assigned a learnable attention weight (a₁, . . . , aₘ), and
classify the image (Iₚ) into one of at least two classes based on the bag-level representation (Z);
receive a new image (I_{N}) of a tissue;
generate a multitude of patches (P(I_{N})₁, . . . , P(I_{N})_{q}) from the new image (I_{N});
input the patches (P(I_{N})₁, . . . , P(I_{N})_{q}) generated from the new image (I_{N}) into the trained machine-learning model (MLM^{t});
receive from the trained machine learning model (MLM^{t}) a first classification result (CR1), the first classification result (CR1) comprising, for each patch (P(I_{N})₁, . . . , P(I_{N})_{q}) inputted into the trained machine-learning model (MLM^{t}), an attention weight (a₁, . . . , a_{q}) assigned to the patch embedding (h₁, h₂, . . . , h_{q}) of the patch (P(I_{N})₁, . . . , P(I_{N})_{q});
select a number of patches (P*(I_{N})₁, . . . , P*(I_{N})ₘ) based on the attention weights (a₁, . . . , a_{q});
input the selected patches (P*(I_{N})₁, . . . , P*(I_{N})ₘ) and/or patches of regions comprising one or more selected patches (P*(I_{N})₁, . . . , P*(I_{N})ₘ) into the trained machine learning model (MLM^{t});
receive from the trained machine learning model (MLM^{t}) a second classification result (CR2), wherein the second classification result (CR2) comprises information about which class of the two classes the new image (I_{N}) was assigned to; and
output the second classification result (CR2) and/or storing the second classification result (CR2) in a data memory and/or transmitting the second classification result (CR2) to a separate computer system.
